(19) United States
(12) Patent Application Publication
(10) Pub. No.: US 2009/0167768 A1
(43) Pub. Date: Jul. 2, 2009

(54) Selective frame rate display of a 3D object

(75) Inventors: William Bull, Campbell, CA (US); Guy Bar-Nahum, Cupertino, CA (US); Gokhan Avkarogullari, Cupertino, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/218,180

(22) Filed: Jul. 10, 2008

Related U.S. Application Data
(60) Provisional application No. 61/009,655, filed on Dec. 31, 2007.

(51) Int. Cl. G06T 15/70

(52) U.S. Cl. 345/473

(57) ABSTRACT

Systems and methods are discussed for performing 3D animation of an object using limited hardware resources. When an object is rotated, the size of the object displayed progressively increases, thus taking up more memory, CPU, and other hardware resources. To limit the impact on resources as an object becomes larger, the electronic device may select to display more small frames of the object at a higher frame rate, and fewer large frames at a lower frame rate, thus providing a uniform 3D animation.

### CROSS-REFERENCE TO RELATED APPLICATIONS

This application claims priority to Bull et al., U.S. Provisional Patent Application No. 61/009,655 (Attorney Docket No. 104677-0183-001), filed Dec. 31, 2007, entitled “Selective Frame Rate Display of a 3D Object,” the entirety of which is incorporated herein by reference.

### BACKGROUND OF THE INVENTION

In general, this relates to providing 3D animation in an electronic device. In particular, this relates to selectively adjusting the frame rate during a 3D animation for the purpose of optimizing resource use in an electronic device.

3D animation is used in a host of electronic applications, ranging from the graphics on cellular phones and digital audio player such as the iPod™ to sophisticated video games and animated movies. Similar to traditional 2D animation, 3D animation fundamentally involves displaying a series of still images at a rate fast enough to create the optical illusion of motion. Each still image is displayed on an electronic screen by manipulating the color and intensity of the pixels that constitute the display.

The process of generating a 3D animation usually begins with describing the object of the animation (e.g. the ball in a bouncing ball animation) using a computer model, such as a wireframe model. The spatial and temporal trajectory of the animation sequence is created by providing multiple frames of the animated object in which the object is incrementally changing. The rate at which the frames are provided is referred to as the frame rate. Lastly, each frame (or a series of frames) is rendered to create a realistic 2D image from the 3D model contained in the frame. The rendering process generally uses the 3D model in each frame to determine the kind of texture and lighting that should be applied to the image so that the finished image has perspective and depth.

The process of creating animation, and in particular the rendering step, can often be computationally very expensive. This can be a particular problem in portable electronic devices, such as cellular phones and digital audio players, where power consumption, memory space, and CPU power are often limiting factors. Thus, there is a need in the art for systems and methods for creating resource-friendly 3D animation.

### SUMMARY OF THE INVENTION

Accordingly, systems, methods and computer-readable medium are provided for generating 3D animation using limited hardware resources.

Nominally, the images that comprise an animation sequence are provided to a screen at a constant rate. However, the amount of computational resources needed to generate each image is not constant. Generally, images that use up more pixels (i.e. screen area) require more resources to model and render. Large incremental change between consecutive images also often leads to more system resource requirements. The present invention can limit the amount of resources needed to create a 3D animation by selectively decreasing the frame rate of the animation during segments that are deemed too resource intensive.

The invention can generate 3D animation with frame rates that are dependent on the computational complexity of rendering each image. The system may include hardware that is configured to store a collection of frames that compose an animation of a 3D object. An optimal frame rate for each frame may be computed based on the resources required for each frame. The system may then select a group of frames to render and provide the rendered images at their associated optimal frame rate to a screen, thereby creating a resource-limited animation.

In one embodiment, the animation is of a rotating object, and in particular, a 2D rotating object such as a music album cover. In this scenario, images of the object that are parallel and almost parallel to the screen are the most computationally expensive to render (i.e., requires significant system resources). Thus, fewer frames of the object in these orientations are rendered and displayed during the animation. The exact point in the animation sequence to slow down the frame rate may be determined by plotting the relationship between the frame number of the animation sequence and the number of pixels occupied by the corresponding image. This plot may be monotonically increasing for a 2D object that is rotated 90 degrees. An upper limit placed on the number of pixels used may translate to the frame number where the frame rate should be decreased.

The computations performed to generate the 3D animation may be carried out on the same device or in two separate devices or pieces of software. In one embodiment, a preprocessor may be used to cache a collection of frames in memory. The preprocessor may compute the optimal frame rate of each frame and store it with the cached frame in, for example, a look up table.

During runtime, the same or a separate device/software may select a group of frames from the collection generated by the preprocessor and order the frames such that the desired animation sequence is created. The frames may then be rendered to create the final images that are seen by the user. Each image may be provided at its optimal frame rate.

In another embodiment, the frame rate during runtime of the system may be a predetermined constant due to the limitations of the hardware or for another reasons. In this case, images with optimal frame rates lower than the runtime frame rate may be held on the screen over multiple frame update cycles, thereby eliminating the need for re-rendering.

Persons of ordinary skill in the art will appreciate that the at least some of the various embodiments described herein can be combined together or they can be combined with other embodiments without departing from the spirit of the present invention.

### BRIEF DESCRIPTION OF THE FIGURES

The above and other objects and advantages of the invention will be apparent upon consideration of the following detailed description, taken in conjunction with the accompanying drawings, in which like reference characters refer to like parts throughout, and in which:

FIG. 1A shows an illustrative electronic device with a display that can be used in accordance with one embodiment of the present invention;

FIG. 1B shows the device of FIG. 1A incorporated into an illustrative network system in accordance with one embodiment of the present invention;

FIG. 2 shows a block diagram of an illustrative electronic device that can be used in accordance with one embodiment of the present invention;

FIG. 3A shows a pictorial diagram illustrating the principles of one embodiment of the present invention;

FIG. 3B shows a graph illustrating how a particular aspect of one embodiment of the present invention may be determined;

FIG. 4 shows a block diagram illustrating the components of a particular embodiment of the present invention;

FIG. 5 shows a flow chart detailing the steps of operation of one embodiment of the present invention.

### DETAILED DESCRIPTION

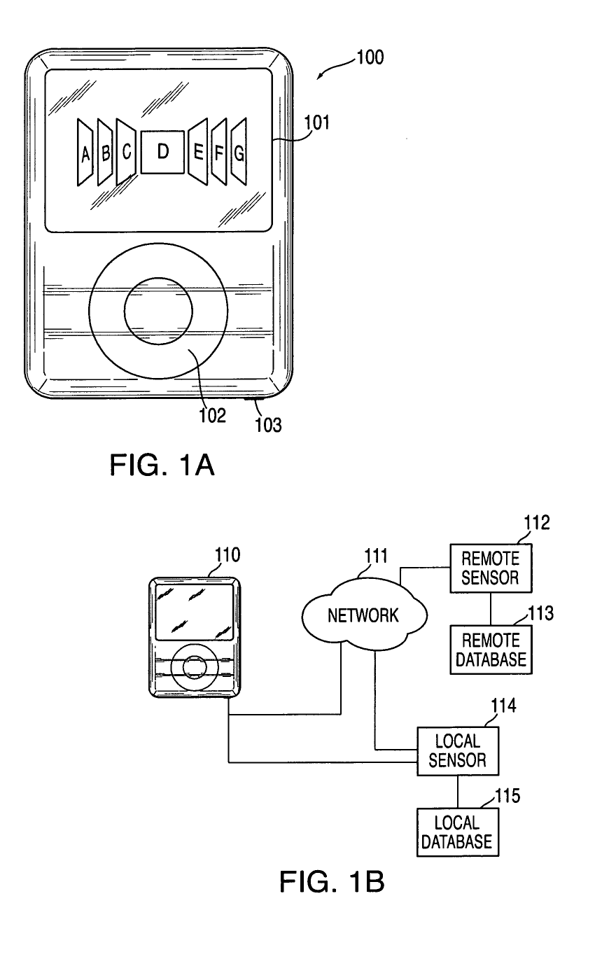

Referring to FIG. 1A, there is shown an illustrative portable electronic device 100, which embodies the principles of one embodiment of the present invention. Electronic device 100 may be a cellular phone, a digital audio player, a PDA, a GPS system, any combination thereof, or any other type of portable electronic device that includes a display screen 101. Display 101 may display videos or simple 2D and/or 3D graphics and animation. One illustration of the contents of display 101 is shown in FIG. 1A as a collection of music album covers that can move in translational and rotational motion across the screen in response to user input. It is understood, however, that display 101 may display any type of 2D or 3D animation that can be generated automatically or in response to a user input.

User input component 102 is illustrated in FIG. 1A as a click wheel. Persons skilled in the art will appreciate that user input component 102 could be any type of user input device that is integrated into or located external to electronic device 100. For example, user input component 102 could also be a mouse, keyboard, audio trackball, slider bar, one or more buttons, electronic device pad, dial, a keypad, a button, a switch, a touch screen, or any combination thereof. User input component 102 may emulate a rotary phone or a multi-button electronic device pad, which may be implemented on a touch screen or the combination of a click wheel or other user input device and a screen. Electronic device 100 may include circuitry, such as a processor and memory, that enables the functions of the device. The circuitry may or may not include a graphics card.

Device 100 can also have a communications port 103 that allows it to communicate with other electronic devices, such as computers, digital audio players, video players, et cetera. Communications port 103 may provide a direct, wired connection to other devices, or it may provide a wireless connection to other devices, or both. For example, port 103 can support one or more of USB, Wi-Fi (e.g., a 802.11 protocol), Ethernet, Bluetooth™ (which is a trademark owned by Bluetooth Sig, Inc.), high frequency systems (e.g., 900 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof.

FIG. 1B shows portable electronic device 110 incorporated into a network system according to one embodiment of the present invention. Portable electronic device 110 may be, for example, device 100 from FIG. 1A. Network 111 may be any type of wired or wireless communications network (or a combination thereof) that utilizes any communications standard(s). One or more remote servers 112 and corresponding database 113 may be connected to network 111. Remote server 112 may be a server operated by a commercial entity, and may offer data, such as music files or supplemental media files. Remote server 112 may or may not charge a fee for its service. Remote server 112 may interact with its database 113 to perform these functions. For example, the aforementioned music and supplemental media data may be stored in database 113.

One or more local servers 114 and corresponding database 115 may also be connected to network 111. Local server 114 and database 115 may be a personal computer, for example. Local server 114 and database 115 may interact with remote server 112 and remote database 113 to obtain the aforementioned data files, among other reasons. The data files may be downloaded by local server 114 automatically or in response to a user input. Local server 114 may or may not be directly connected to portable device 110, and the steps of certain computations and processes may be performed partially on local server 114 and partially on portable device 110.

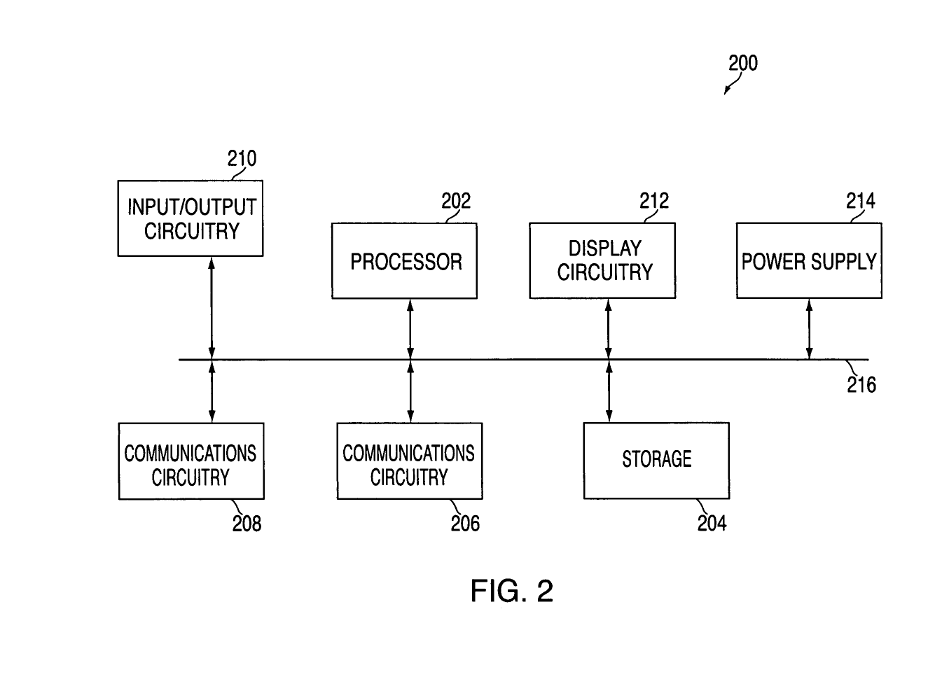

FIG. 2 illustrates a simplified schematic diagram of an illustrative electronic device or devices in accordance with one embodiment of the present invention. Electronic device 200 can be any device that has a display screen including, but not limited to, a portable media player, a video player, a cellular telephone, a computer, a personal organizer, a GPS system, a hybrid of such devices, or combinations thereof. Electronic device 200 may perform a single function (e.g., a device that plays music, such as an iPod™ marketed by Apple Inc.). Electronic device 200 may also perform multiple functions (e.g., a device that plays music, displays video, stores pictures, and receives and transmits telephone calls, such as an iPhone™ marketed by Apple Inc.). Electronic device 200 can be implemented in or as any type of electronic device or devices, such as, for example, electronic device 100 as discussed above.

Electronic device 200 can include control processor 202, storage 204, memory 206, communications circuitry 208, input/output circuitry 210, display circuitry 212 and/or power supply circuitry 214. In some embodiments, electronic device 200 can include more than one of each component or circuitry, but for sake of simplicity, only one of each is shown in FIG. 2. In addition, one skilled in the art would appreciate that the functionality of certain components and circuitry can be combined or omitted and that additional components and circuitry, which are not shown in FIGS. 1 and 2, can be included in electronic devices 100 and 200.

Processor 202 can be configured to perform any function. Processor 202 may be used to run operating system applications, firmware applications, media playback applications, media editing applications, and/or any other application.

Storage 204 can be, for example, one or more storage mediums, including for example, a hard-drive, flash memory, permanent memory such as ROM, any other suitable type of storage component, or any combination thereof. Storage 204 may store, for example, media data (e.g., graphics data files), application data, firmware, wireless connection information data (e.g., information that may enable electronic device 200 to establish a wireless connection), subscription information data (e.g., information that keeps track of podcasts or audio/video broadcasts or other media a user subscribes to), contact information data (e.g., telephone numbers and email addresses), calendar information data, any other suitable data, or any combination thereof.

Memory 206 can include cache memory, semi-permanent memory such as RAM, and/or one or more different types of memory used for temporarily storing data. Memory 206 can also be used for storing data used to operate electronic device applications.

Communications circuitry 208 can permit device 200 to communicate with one or more servers or other devices using any suitable communications protocol. For example, communications circuitry 208 may support Wi-Fi (e.g., a 802.11 protocol), Ethernet, Bluetooth™ (which is a trademark owned by Bluetooth Sig, Inc.), high frequency systems (e.g., 900 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof.

Input/output circuitry 210 can convert (and encode/decode, if necessary) analog signals and other signals (e.g., physical contact inputs (from e.g., a multi-touch screen), physical movements (from, e.g., a mouse), analog audio signals, etc.) into digital data. Input/output circuitry can also convert digital data into any other type of signal vice-versa. The digital data can be provided to and received from processor 202, storage 204, memory 206, or any other component of electronic device 200. Although input/output circuitry 210 is illustrated in FIG. 2 as a single component of electronic device 200, a plurality of input/output circuitry can be included in electronic device 200. Input/output circuitry 210 can be used to interface with any input or output component, such as those discussed in connection with FIG. 1A. For example, electronic device 200 can include specialized input circuitry associated with (e.g., one or more microphones, cameras, proximity sensors, accelerometers, ambient light detectors, etc.). Electronic device 200 can also include specialized output circuitry associated with output devices such as, for example, one or more speakers, etc.

Display circuitry 212 can accept and/or generate signals for presenting media information (textual and/or graphical) on a display such as those discussed below. For example, display circuitry 212 can include a coder/decoder (CODEC) to convert digital media data into analog signals. Display circuitry 212 also can include display driver circuitry and/or circuitry for driving display driver(s). The display signals can be generated by processor 202 or display circuitry 212. The display signals can provide media information related to media data received from communications circuitry 208 and/or any other component of electronic device 200. In some embodiments, display circuitry 212, like any other component discussed herein, can be integrated into and/or electrically coupled to electronic device 200.

Power supply 214 can provide power to the components of device 200. In some embodiments, power supply 214 can be coupled to a power grid (e.g., a wall outlet or automobile cigarette lighter). In some embodiments, power supply 214 can include one or more batteries for providing power to a portable electronic device. As another example, power supply 214 can be configured to generate power in a portable electronic device from a natural source (e.g., solar power using solar cells).

Bus 216 can provide a data transfer path for transferring data to, from, or between control processor 202, storage 204, memory 206, communications circuitry 208, and any other component included in electronic device.

In some embodiments, electronic device 200 may be coupled to a host device (not shown) for performing any suitable operation that may require electronic device 200 and a host device to be coupled. The host device may perform operations such as data transfers and software or firmware updates. The host device may also execute one or more operations in lieu of electronic device 200 when memory 206 does not have enough memory space, or processor 202 does not have enough processing power to perform the operations efficiently. For example, if electronic device 200 is required to render images that are too large to be stored in memory 206, electronic device 200 may be coupled to a host device for the host device to execute the computations. Alternatively, the host device may perform one or more operations in conjunction with electronic device 200 so as to increase the efficiency of electronic device 200. For example, if electronic device 200 needs to perform several steps in a process, electronic device 200 may execute some of the steps while the host device executes the rest.

The host device may be any device that is suitable for executing operations that the host device may need to execute when coupled to electronic device 200. The host device may be a device that is capable of functioning like electronic device 200 (e.g., a device that is capable of producing 3D animation). In some embodiments, a plurality of electronic devices may be coupled to a host device to share data using the host device as a server. In other embodiments, an electronic device may be coupled to a plurality of host devices (e.g., for each of the host devices to serve as a backup for data stored in the electronic device).

Electronic device 200 may be coupled with a host device over a communications link using any suitable approach. As an example, the communications link may be any suitable wireless connection. The communications link may support any suitable wireless protocol such as, for example, Wi-Fi (e.g., a 802.11 protocol), Bluetooth®, infrared, GSM, GSM plus EDGE, CDMA, quadband, or any other suitable wireless protocol. Alternatively, the communications link may be a wired link that is coupled to both electronic device 200 and the host device (e.g., a wire with a USB connector or a 30-pin connector). A combination of wired and wireless links may also be used to couple electronic device 200 with a host device.

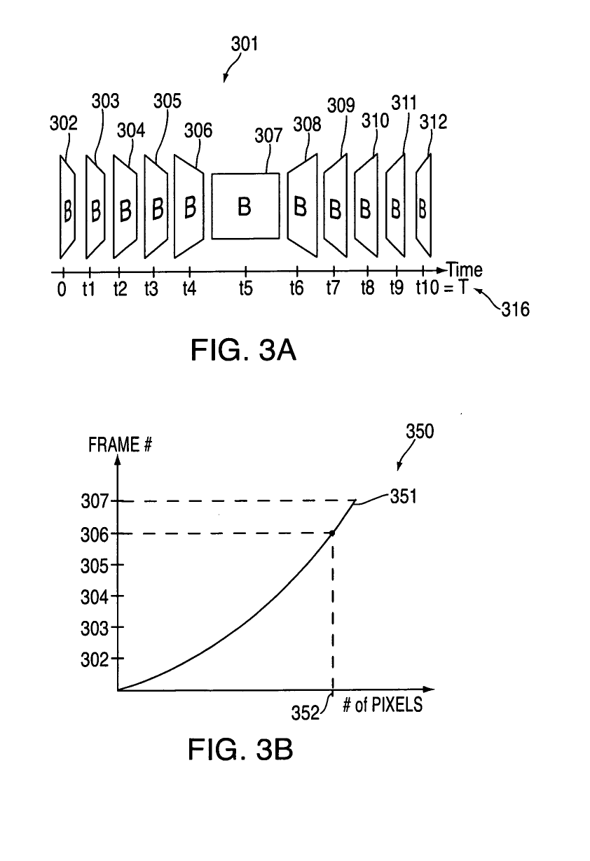

Referring now to FIG. 3A, there is shown a pictorial diagram illustrating the principles of variable frame rate animation that can be applied in accordance with one embodiment of the present invention. FIG. 3A, for example, shows eleven frames 302-312 that constitute an animation of a rotating object 301. Each frame 302-312 depicts 3D object 301 in a different orientation. When provided in succession to an electronic display screen at a fast enough rate, frames 302-312 create the optical illusion of a rotating object 301. The display screen may, for example, be display 101 of FIG. 1A.

Object 301, for illustration purposes, is shown in FIG. 3A as a music album cover. However, one skilled in the art would appreciate that object 301 may be any animated object. Object 301 may be defined using a mathematical or computerized model, such as a wireframe model, or by another method such as claymation. The letter “B” on object 301 is provided for clarity to indicate the orientation of object 301 in each frame 302-312. FIG. 3A illustrates how object 301 can change with respect to time, and should not be confused with the contents of display 101 of FIG. 1A, which is a spatial illustration.

Time axis 316 indicates the temporal order in which frames 302-312 can be provided to the display screen to create the animation. In particular, frame 302 can be provided at time 0, frame 303 can be provided at time t₁, frame 304 is provided at time t₂, et cetera. Frames 303-312 can be provided in succession at a specified rate to create a 3D animation of object 301 rotating 180 degrees clockwise. Although it is not explicitly shown in FIG. 3A, object 301 may also undergo translational motion at the same time. For example, object 301 may move from the left side of the display area to the right side while it is rotating. It is understood that the animation scenarios described herein are only for illustrative purposes. Other animation sequences and objects may also be used within the scope of the invention.

Nominally, the frame rate of an animation, the rate at which the frames are updated, is constant during the entire length of the animation. For example, a commonly used frame rate is 30 frames per second (fps), although higher and lower frame rates may also used in many applications. For example, an eleven frame animation operating at a constant frame rate of 30 fps would run for T=0.37 seconds. However, in accordance with embodiments of the present invention, using a frame rate that is variable during an animation may have certain performance advantages for the reasons discussed below.

The amount of hardware resources used in rendering an image from a model is highly dependent on the complexity of the image. In many cases, the complexity of an image is correlated with the screen area (i.e. the number of pixels) that the image occupies. The incremental change in occupied screen area between consecutive frames also leads to more complexity. For example, it requires more hardware resources to model, render, and display frames 306-308 in an animation than frames 302-305 and 309-312, because the images resulting from frames 306-308 utilize more pixels than that of the other frames, and because the incremental change in pixel use between the images of frames 306-308 is greater than that of the other frames. Thus, a decrease in overall resource use in generating an animation sequence may be achieved by selectively decreasing the frame rate during an expensive segment of an animation sequence. In this manner, resource intensive frames are provided a fewer number of times.

Examples of resources that may be saved by using the scheme described above include memory, power, CPU operation, and other types of electronic resources. This is especially important for portable electronic devices, where hardware resources are limited, and the fact that the use of those resources can cause a severe drain on the battery, resulting in reduced useful life of the product between charges. In particular, many portable electronic devices that do not contain a graphics card, or other hardware dedicated to performing the expensive computations required in animation, would benefit from the present invention.

With continued reference to FIG. 3A, tick marks tᵢ on time axis 316 denote the time at which each individual frame 302-316 is provided during the illustrated animation sequence. The animation sequence in this instance is T seconds in length. In accordance with the discussion above, frames 306-308 are provided at a faster rate than frames 302-305 and frames 309-312. This difference in frame rates may be achieved by selectively increasing the rate for frames 304-306 above a baseline value (e.g. 30 fps) or by selectively lowering the rate for frames 302-305 and 309-312 below a baseline value or by doing a combination of both. By doing a combination of both, the overall animation length may stay the same as when the baseline rate is used.

Although the above discussion focuses on animation sequences with two different frame rates, it is understood that any number of different frame rates may be used during an animation sequence to produce the desired resource-saving effects. The changes in frame rate may also be continuous rather than at discrete intervals.

FIG. 3B shows a plot 350 that may be used to determine where to decrease the frame rate in accordance with embodiments of the present invention in a rotational animation sequence like that of FIG. 3A. On the abscissa of plot 350 is the number of pixels required by a particular frame of an animation sequence. This may be measured in absolute numbers or as percentages of the whole screen. On the ordinate of plot 350 is the corresponding frame number. The frame number may be denoted in any manner (e.g., percentages, ordinal numbers, running time of the animation, etc), as long as the correct sequence of the images is preserved. Curve 351 illustrates the relationship between the frame number and the number of required pixels in the rotation animation shown in FIG. 3A. Referring back to FIG. 3A, frame 302 requires a relatively small number of pixels. As the frame number increases, so does the number of required pixels. This is illustrated by curve 351 in FIG. 3B. There is a certain point 352 in the animation sequence where the number of pixels required by a frame exceeds the optimal resource usage (e.g. memory usage, CPU usage, etc.) by the device. The frame rate may be decreased at the frame number corresponding to point 352.

Curve 351 provides a characterization of the animation trajectory and may take a variety of shapes. In a 90 degree rotation of a flat object, like the first half of the animation shown in FIG. 3A, curve 351 may be a logarithmic curve or another monotonically increasing and concave up curve. Continued rotation of a flat object would result in a periodic shape for curve 351.

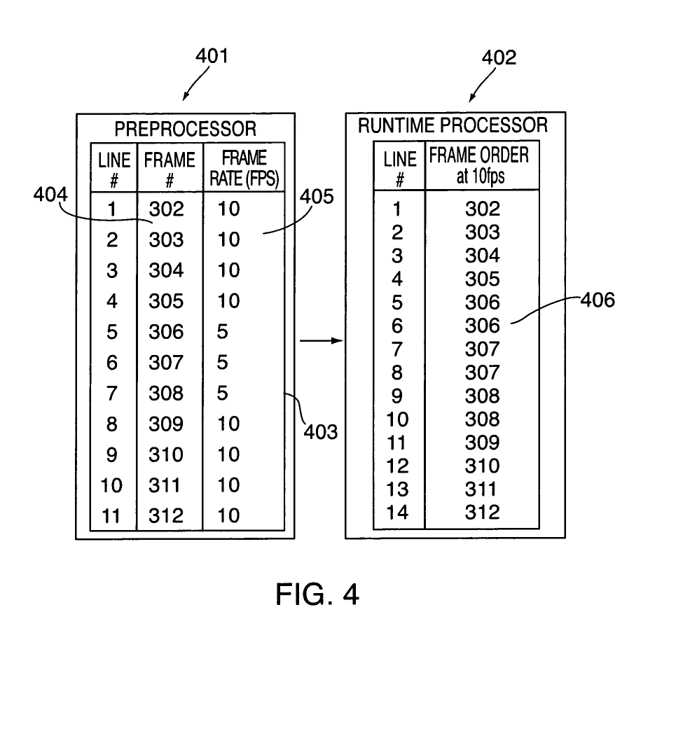

Referring now to FIG. 4, there is shown a simplified block diagram illustrating the components of a particular embodiment of the invention. The computations for generating a 3D animation may be performed on two components: preprocessor 401 and runtime processor 402. Although FIG. 4 shows preprocessor 401 and runtime processor 402 as two distinct modules, it is understood that they may be implemented on one or multiple physical devices or pieces of software. For example, a single processor could be used to perform preprocessing and runtime processing. In another instance, preprocessing and/or runtime processing can be performed on different processors, or even divided among multiple cores on a single processor. Persons of ordinary skill in the art will appreciate that there are numerous different configurations for the processors that can be utilized in accordance with embodiments of the present invention.

In one embodiment, preprocessor 401 may be a software program, such as iTunes™, that runs on a server or other computing device, such as local server 114 of FIG. 1B. Preprocessor 401 may also be implemented directly in the circuitry or software of a portable electronic device, such as device 110 of FIG. 1B. In preprocessor 401, the frames of an animation (e.g. frames 302-312 of FIG. 3A) are cached in memory. Preprocessor 401 may also determine the frame rate for each frame that optimizes quality and resource use. This calculation may involve, for example, finding a point such as point 352 of FIG. 3B on a curve characterizing the particular animation in question.

For example, preprocessor 401 may generate table 403 for a particular animation object, such as object 301 of FIG. 3A. Table 403 maps a particular frame number 404 of an animation object to a frame rate 405. Frame numbers 404 may be named based on any type of naming convention, numerical or non-numerical, that establishes a correspondence between frame number 404 and a cached frame image. For example, the first line of table 403 indicates that a particular frame (e.g. frame 302 of FIG. 3A) should be provided at 10 fps. Frame rate 405 may be different for different frame numbers. Lines 5-7 of table 403 indicate the drop in frame rate that was illustrated for frames 306-308 of FIG. 3A. It is understood that the numbers provided for frame number 404 and frame rate 405 in FIG. 4 are for illustrative purposes only, and may in fact equal a variety of values. Preprocessor 401 may generate table 403 for each of a collection of animation objects that may be displayed concurrently with each other or at different points in time. Table 403 may be implemented using any appropriate hardware or software method. For example, table 403 may be a look-up table implemented in a ROM.

The remainder of the computations for generating an animation may be performed on runtime processor 402. In one embodiment, runtime processor 402 may be implemented in the circuitry or software of a portable electronic device, such as device 110 of FIG. 1B. Runtime processor 402 may be implemented on the same device or software as preprocessor 401 or on a different device or software. For example, runtime processor 402 may be included in the hardware or software of an iPod™ or other portable media device. Runtime processor 402 may select some or all of the cached frames to display and the order in which they are displayed. In one embodiment, runtime processor 402 may generate table 406 to store the frame selection and order of the cached frames. This determination may be done automatically or in response to user input, such as a roll or click of user input component 102 of FIG. 1A. Runtime processor 402 may generate a list 406 of the upcoming frames to display. Runtime processor 402 may also use table 403 generated by preprocessor 401 to determine the frame rate at which each displayed frame should be provided.

In some cases, runtime processor 402 may have a predetermined rate at which it updates the display. For example, runtime processor 402 may display 10 frames per second regardless of the animation sequence that is being shown. In these cases, frames that could be provided optimally at a lower rate than the frame rate of runtime processor 402 may be held over multiple frame cycles (i.e., rather than changing the frame and incurring expense in system resources, the frame remains as it was for one or more extra cycles). For example, if runtime processor 402 runs at 10 fps and selects all of the cached frames 404 from preprocessor 401 to display, it may hold frames 306-308 over two cycles because the frame rate of frames 306-308 is only 5 fps according to preprocessor 401. By holding frames 306-308 over multiple cycles, calculations such as rendering calculations need not be performed unnecessarily, thereby decreasing the use of system resources (or not increasing the use of those resources which would otherwise occur). Runtime processor 402 creates upcoming frames list 406 to reflect this detail by listing each of frames 306-308 twice. Using upcoming frames list 406, runtime processor 402 may render the images and display the images at the predetermined frame rate to create the 3D animation.

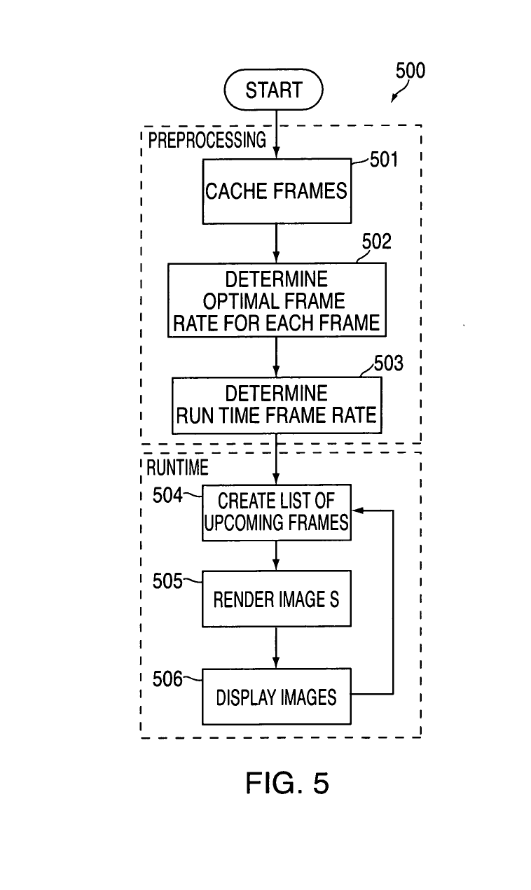

Referring now to FIG. 5, there is shown an illustrative flow chart 500 that details the steps taken to create a 3D animation on a portable electronic device using limited computational resources in accordance with embodiments of the present invention. Steps 501-503 can be performed as part of preprocessing while steps 504-506 can be performed as part of the runtime processing (as previously described, these steps can be performed in one processor, multiple processors, one processor with multiple cores, etc.).

At step 501, frames of one or more animated 3D objects are cached in to memory. This may be done by a preprocessor that is part of or separate from the portable electronic device. For example, if the portable device is an iPod™, the frames may be cached by iTunes™ software on the memory of a personal computer. A selection of frames that are most likely to be displayed in the near future may be cached in the memory of the iPod™ as well. Alternatively, all the frames may be cached directly in the portable electronic device.

At step 502, the optimal frame rate for each cached frame is determined by assessing the computational complexity of rendering and displaying each cached frame. Persons of ordinary skill in the art will appreciate that, in accordance with some embodiments of the present invention, the assessment of optimal frame rate can be performed even earlier, offline, and downloaded with the frames in to cache memory as part of step 501. As described previously, the computational complexity of generating an image generally increases as the number of pixels occupied by that image increases. The computational complexity can also increase when the incremental change between two consecutive images in an animation sequence is large. Since complex computations typically require more hardware resources, the frame rate, in accordance with embodiments of the present invention, is selectively reduced for such images.

For purpose of illustration, in one scenario, the animated object has a flat rectangular shape and undergoes a 3D rotation during the animation. As the object rotates from being perpendicular to the screen to being parallel with it, the frame rate is selectively decreased to limit the resources used by these expensive images. The cached frames and their associated frame rates may be organized into a table, such as table 401 of FIG. 4, or another functionally equivalent structure. When a cached frame is later rendered and displayed during runtime, the frame rate at which it should be provided may be easily determined from the table.

Although variable frame rates are computed for each frame in step 502, the rate at which the screen of the portable electronic device is updated may be a predetermined constant. For example, the frame rate of a device might be a function of the speed in hertz of the processor. Additionally, if an animation is comprised of two or more objects, the computationally expensive frames of each object may occur at alternating times during the animation (e.g. two disks rotating out of sync). In this case, it may not be possible to actually slow down or increase the runtime frame rate of the device. Accordingly, the actual runtime frame rate at which the portable device operates is determined at step 503. This step may involve simply determining the predetermined frame rate of the portable device or computing a frame rate that is a common factor of the optimal frame rates found in step 502 of each object in the animation.

The steps described above may occur during preprocessing. During runtime, the temporal layout of the animation may be determined. At step 504, a list of upcoming frames is created or modified. The frames on this list are displayed sequentially at the runtime frame rate calculated in step 503. Frames with optimal frame rates lower than that of the runtime frame rate may be held on the screen over multiple consecutive cycles. Since this list of upcoming frames may dynamically change in response to user input, such as in the cover flow user interface of the iPod™ and iPhone™, step 504 may be performed many times or even continuously.

At step 505, the frames on the list created in step 504 are rendered to create the images in the final animation. Rendering is the process of displaying the 3D objects in the frames cached in step 501 onto a 2D screen. Rendering may add texture to the objects. For example, light reflection properties may be added to the objects to create the 3D effect. These rendered images are then displayed onto a device screen in the order and frame rate that was specified in step 504, thereby creating a 3D animation at step 506.

It will be understood that the foregoing is only illustrative of the principles of the invention, and that various modifications can be made by those skilled in the art without departing from the scope and spirit of the invention, and the present invention is limited only by the claims that follow.

What is claimed is:

1. A system for creating an animation comprising:
memory operative to store a collection of frames of an animated object;
processing circuitry operative to compute an optimal frame rate for each frame based, at least in part, on an amount of hardware resources required to render each frame;
rendering circuitry operative to selectively render a plurality of frames from the collection of frames; and
output circuitry operative to provide each of the rendered frames at its computed optimal frame rate to an output display to produce a continuous animation.

2. The system of claim 1, wherein frames in a first segment of the animation have a first optimal frame rate; and
frames in a second segment of the animation have a second optimal frame rate which is different than the first optimal frame rate.

3. The system of claim 2, wherein the animation is a 3D animation of a rotating 2D object.

4. The system of claim 3, wherein the rotating 2D object is a music album cover.

5. The system of claim 3, further comprising:
translation circuitry operative to apply translational motion to the rotating 2D object concurrently during the animation.

6. The system of claim 3, wherein the rotating 2D object is substantially perpendicular to the output display at a beginning of the animation and substantially parallel to the output display at an end of the animation, such that the 2D object rotates approximately 90 degrees during the animation.

7. The system of claim 6, wherein each frame has a frame number corresponding to when the frame is displayed in a sequence with respect to other frames in the sequence, wherein frame number and number of pixels required to display the frame are related in a monotonically increasing manner.

8. The system of claim 7, wherein a point of transition between the first segment and the second segment is based, at least in part, on properties of the monotonically increasing relationship.

9. The system of claim 1, wherein the processing circuitry comprises a preprocessor and the rendering circuitry comprises a runtime processor.

10. The system of claim 9, wherein the preprocessor and the runtime processor are in two different physical devices.

11. The system of claim 9, wherein the preprocessor and the runtime processor are part of the same physical device.

12. The system of claim 9, wherein the preprocessor is configured to cache the collection of frames in the memory.

13. The system of claim 9, wherein the optimal frame rate for each frame in the collection of frames is computed by the preprocessor; and
wherein the preprocessor is configured to create a look-up table associating each frame in the collection of frames with its optimal frame rate.

14. The system of claim 9, wherein the runtime processor is configured to select a group of frames that will be rendered.

15. The system of claim 9, wherein the runtime processor is configured to determine an order in which rendered frames will be provided to the output display.

16. The system of claim 9, wherein the runtime processor provides rendered frames to the output display at a predetermined runtime frame rate that is constant during the animation;
wherein the runtime frame rate is at least as fast as the fastest computed optimal frame rate, and
wherein the rendered frames with optimal frame rates slower than the runtime frame rate are displayed on the output display over multiple frame update cycles.

17. A method for creating an animation comprising:
storing a collection of frames of an animated object in a memory;
computing an optimal frame rate for each frame in the collection of frames, based at least in part on which hardware resources are required to render each frame;
rendering a select group of frames from the collection of frames; and
providing each of the rendered frames at its computed optimal frame rate to an output display to produce a continuous animation.

18. The method of claim 17, wherein the frames in a first segment of the animation are provided at a first optimal frame rate; and
the frames in a second segment of the animation are provided at a second optimal frame rate which is different than the first optimal frame rate.

19. The method of claim 18, wherein the animation is a 3D animation of a rotating 2D object.

20. The method of claim 19, further comprising:
causing the rotating, 2D object to undergo translational motion concurrently during the animation.

21. The method of claim 17, wherein computing occurs during a preprocessing phase and rendering occurs during a runtime phase.

22. The method of claim 21, wherein the preprocessing phase comprises:
caching the collection of frames in a memory;
computing the optimal frame rates for each cached frame; and
determining a runtime frame rate, wherein the runtime frame rate is constant throughout the duration of the animation, and wherein the runtime frame rate is at least as fast as the fastest computed optimal frame rate.

23. The method of claim 22, wherein the runtime phase comprises:
selecting a group of frames to be rendered;
determining the order in which the selected frames is provided to the output display;
rendering the selected frames; and
providing the rendered frames to the output display at the runtime frame rate to produce a continuous animation.

24. The method of claim 23, wherein the rendered frames with optimal frame rates that are slower than the runtime frame rate are displayed on the output display over multiple frame update cycles.

25. A computer readable medium containing at least computer program code for creating an animation, comprising:
computer program code for storing a collection of frames of an animated object in a memory;
computer program code for computing an optimal frame rate for each frame that is based at least in part on the amount of hardware resources required to render the frame;
computer program code for selectively rendering a group of frames from the collection of frames; and
computer program code for providing each of the rendered frames at its computed optimal frame rate to an output display to produce a continuous animation.
